(19) United States
(12) Patent Application Publication
(10) Pub. No.: US 2026/0181693 A1
(43) Pub. Date: Jun. 25, 2026

(54) SYSTEM AND METHOD FOR PRIORITIZED EDCA BACKOFF

(71) Applicant: NXP USA, Inc., AUSTIN, TX (US)

(72) Inventors: Kiseon Ryu, San Diego, CA (US); Liwen Chu, San Ramon, CA (US); Huizhao Wang, San Jose, CA (US); Hongyuan Zhang, Fremont, CA (US)

(21) Appl. No.: 19/431,495

(22) Filed: Dec. 23, 2025

Related U.S. Application Data
(60) Provisional application No. 63/738,062, filed on Dec. 23, 2024.
(60) Provisional application No. 63/759,311, filed on Feb. 17, 2025.

(51) Int. Cl. H04W 74/0816

(52) U.S. Cl. CPC H04W 74/0816

(57) ABSTRACT

Embodiments of a method and apparatus for wireless communications are disclosed. In an embodiment, a wireless device includes a controller configured to store Enhanced Distributed Channel Access (EDCA) backoff parameters when enabling a prioritized EDCA (P-EDCA) channel access for low latency (LL) access category (AC), and a wireless transceiver configured to perform the P-EDCA channel access by wirelessly transmitting a control frame using P-EDCA parameters, where the controller is further configured to resume an EDCA backoff procedure using the stored EDCA backoff parameters when a certain condition is met.

### CROSS-REFERENCE TO RELATED APPLICATIONS

This application is entitled to the benefit of U.S. Provisional Patent Application Ser. No. 63/738,062, filed on Dec. 23, 2024 and U.S. Provisional Patent Application Ser. No. 63/759,311, filed on Feb. 17, 2025, the contents of each of which are incorporated by reference herein in their entireties.

### SUMMARY

Embodiments of a method and apparatus for wireless communications are disclosed. In an embodiment, a wireless device includes a controller configured to store Enhanced Distributed Channel Access (EDCA) backoff parameters when enabling a prioritized EDCA (P-EDCA) channel access for low latency (LL) access category (AC), and a wireless transceiver configured to perform the P-EDCA channel access by wirelessly transmitting a control frame using P-EDCA parameters, where the controller is further configured to resume an EDCA backoff procedure using the stored EDCA backoff parameters when a certain condition is met. Other embodiments are also disclosed.

In an embodiment, the wireless device includes a non-access point (AP) station (STA) or an AP.

In an embodiment, the P-EDCA parameters include a P-EDCA parameter set for defer signal transmission.

In an embodiment, the P-EDCA parameter set for defer signal (DS) transmission includes an arbitration inter-frame space number (AIFSN), a contention window (CW), and a defer signal retry counter.

In an embodiment, the P-EDCA parameters include a P-EDCA parameter set for request to send (RTS) transmission that follows defer signal transmission.

In an embodiment, the P-EDCA parameter set for RTS transmission includes an arbitration inter-frame space number (AIFSN) and a contention window (CW).

In an embodiment, the wireless transceiver is further configured to retry the P-ECDA channel access until the certain condition is met when the P-EDCA channel access is not successful.

In an embodiment, when the certain condition is met, a regular EDCA procedure is resumed.

In an embodiment, the certain condition includes at least one of:
P-EDCA retrial reaches a predetermined limit;
an LL AC frame transmission under the P-EDCA channel access is successful;
the P-EDCA channel access is disabled by an AP's announcement;
no buffered unit in a P-EDCA queue; and
an LL data frame under retransmission is discarded because a life time or a delay bound of the LL data frame is reached.

In an embodiment, the predetermined limit is a defer signal (DS) retry limit.

In an embodiment, a CW of regular EDCA for LL AC is set to CWminimum if the LL AC frame transmission under the P-EDCA channel access is successful.

In an embodiment, a CW of regular EDCA for LL AC is set to a smaller value of CWmaximum[AC] and 2^{QSRC[AC]}×(CWminimum[AC]+1)−1) if the P-EDCA retrial reaches the predetermined limit, where QSRC stands for Quality of Service (QoS) Short Retry Counter.

In an embodiment, a non-AP wireless station (STA) includes a controller configured to store Enhanced Distributed Channel Access (EDCA) backoff parameters when enabling a prioritized EDCA (P-EDCA) channel access for low latency (LL) access category (AC) and a wireless transceiver configured to perform the P-EDCA channel access by wirelessly transmitting a control frame to an AP using P-EDCA parameters, where the P-EDCA parameters include at least one of an arbitration interframe space number (AIFSN) and a contention window value, where the controller is further configured to resume an EDCA backoff procedure using the stored EDCA backoff parameters when a certain condition is met.

In an embodiment, a method for wireless communications involves at a wireless device, storing Enhanced Distributed Channel Access (EDCA) backoff parameters when enabling a prioritized EDCA (P-EDCA) channel access for low latency (LL) access category (AC), at the wireless device, performing the P-EDCA channel access by wirelessly transmitting a control frame using P-EDCA parameters, and at the wireless device, resuming an EDCA backoff procedure using the stored EDCA backoff parameters when a certain condition is met.

In an embodiment, the wireless device includes a non-access point (AP) station (STA) or an AP.

In an embodiment, the P-EDCA parameters include a P-EDCA parameter set for defer signal transmission.

In an embodiment, the P-EDCA parameter set for defer signal transmission includes an arbitration inter-frame space number (AIFSN), a contention window (CW), and a defer signal retry counter.

In an embodiment, the P-EDCA parameters include a P-EDCA parameter set for request to send (RTS) transmission that follows defer signal transmission.

In an embodiment, the P-EDCA parameter set for RTS transmission includes an arbitration inter-frame space number (AIFSN) and a contention window (CW).

In an embodiment, the method further includes retrying the P-ECDA channel access until the certain condition is met when the P-EDCA channel access is not successful.

Other aspects in accordance with the disclosure will become apparent from the following detailed description, taken in conjunction with the accompanying drawings, illustrated by way of example of the principles of the disclosure.

### BRIEF DESCRIPTION OF THE DRAWINGS

FIG. 1 depicts a wireless communications system in accordance with example embodiments.

FIG. 2 depicts a multi-link (ML) communications system that is used for wireless communications in accordance with example embodiments.

FIG. 3 depicts a wireless device in accordance with example embodiments.

FIG. 4 illustrates a P-EDCA parameter set in accordance with example embodiments.

FIG. 5 shows an example P-EDCA procedure.

FIG. 6 shows a successful P-EDCA channel access with no retrial in accordance with example embodiments.

FIG. 7 shows a P-EDCA channel access with retrial in accordance with example embodiments.

FIG. 8 shows a P-EDCA channel access with retrial reached to a retrial limit in accordance with example embodiments.

FIG. 9 shows a P-EDCA parameter update for P-EDCA retrial in accordance with example embodiments.

FIG. 10 is a process flow diagram of a method for wireless communications in accordance with example embodiments.

Throughout the description, similar reference numbers may be used to identify similar elements.

### DETAILED DESCRIPTION

Wireless communications devices, e.g., access points (APs) or non-AP devices transmit various types of information using different transmission techniques. For example, various applications, such as, Internet of Things (IoT) applications conduct wireless local area network (WLAN) communications, for example, based on Institute of Electrical and Electronics Engineers (IEEE) 802.11 family of standards (e.g., Wi-Fi standards). In multi-link communications, an access point (AP) multi-link device (MLD) wirelessly transmits data to one or more wireless stations in a non-AP MLD through one or more wireless communications links. Some applications, for example, video teleconferencing, streaming entertainment, high definition (HD) video surveillance applications, outdoor video sharing applications, etc., require relatively high system throughput. To facilitate the proper data transmission within a wireless communications system, there is a need for wireless communications technology that can efficiently and securely convey wireless communications information, for example, information related to data, communications links, and/or wireless devices (e.g., operation and/or capability parameters of wireless devices) within the wireless communications system.

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussions of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize, in light of the description herein, that the disclosure can be practiced without one or more of the specific features or advantages of a particular embodiment. In other instances, additional features and advantages may be recognized in certain embodiments that may not be present in all embodiments of the disclosure.

Reference throughout this specification to “one embodiment”, “an embodiment”, or similar language means that a particular feature, structure, or characteristic described in connection with the indicated embodiment is included in at least one embodiment of the present disclosure. Thus, the phrases “in one embodiment”, “in an embodiment”, and similar language throughout this specification may, but do not necessarily, all refer to the same embodiment.

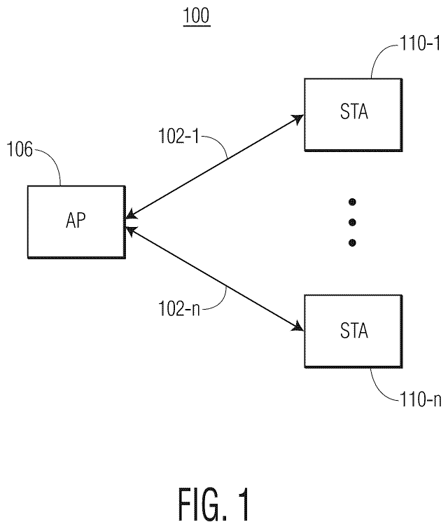

FIG. 1 depicts a wireless (e.g., WiFi) communications system 100 in accordance with example embodiments. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications link. In some embodiments, the AP 106 may be affiliated with an AP MLD, and a STA 100-j with j being an integer equal to one of 1 to n may be affiliated with a STA MLD j (=non-AP MLD j).

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received physical layer (PHY) protocol data units (PPDUs) through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., beacon, association establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band.

In the embodiment depicted in FIG. 1, each of the at least one STA 110-1, . . . , 110-n may be implemented in hardware (e.g., circuits), software, firmware, or a combination thereof. The STA 110-1, ..., or 110-n may be fully or partially implemented as IC devices. In some embodiments, the STA 110-1, . . . , or 110-n is a communication device compatible with at least one IEEE 802.11 protocol. In some embodiments, the STA 110-1, ..., or 110-n is implemented in a laptop, a desktop personal computer (PC), a mobile phone, or other communications device that supports at least one WLAN communications protocol. In some embodiments, the STA 110-1, . . . , or 110-n implements upper layer MAC functionalities and lower layer MAC layer functionalities. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received PPDUs through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes MAC protocol data units (MPDUs). An MPDU may include a frame header, a frame body, and a trailer with the MPDU payload encapsulated in the frame body.

In some embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an Ultra High Reliability (UHR) communication protocol, or an Institute of Electrical and Electronics Engineer (IEEE) 802.11 communication protocol (e.g., an IEEE 802.11bn communication protocol). In some embodiments of the wireless communications system described herein, different associated STAs within range of an AP operating according to the UHR communication protocol are configured to operate according to at least one other communication protocol, which defines operation in a Basic Service Set (BSS) with the AP, but are generally affiliated with lower reliable protocols. The lower reliable communication protocols (e.g., Extremely High Throughput (EHT) communication protocol that is compatible with IEEE 802.11be standards, High Efficiency (HE) communication protocol that is compatible with IEEE 802.11ax standards, Very High Throughput (VHT) communication protocol that is compatible with IEEE 802.11ac standards, etc.) may be collectively referred to herein as “legacy” communication protocols.

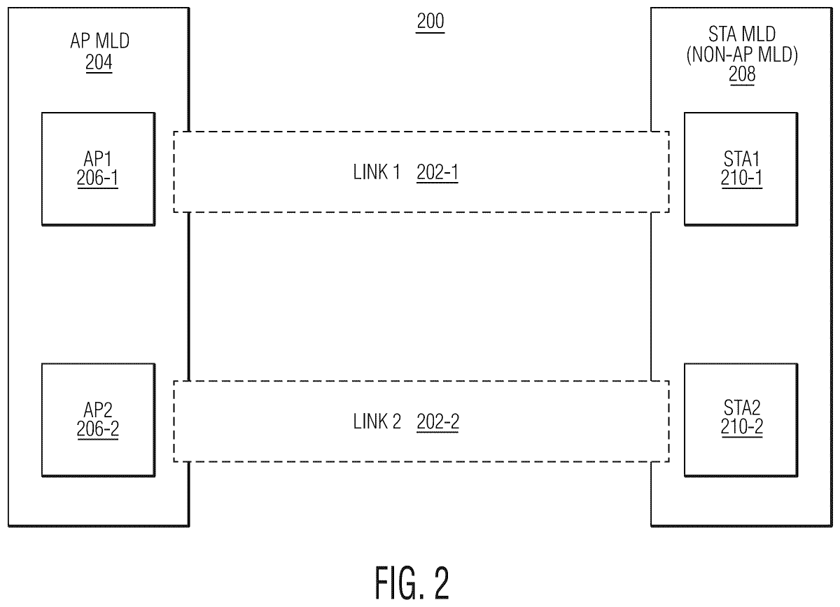

FIG. 2 depicts a multi-link (ML) communications system 200 that is used for wireless (e.g., WiFi) communications in accordance with example embodiments. In the embodiment depicted in FIG. 2, the multi-link communications system includes one AP multi-link device, which is implemented as AP MLD 204, and one non-AP STA multi-link device, which is implemented as STA MLD (non-AP MLD) 208. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Although the depicted multi-link communications system 200 is shown in FIG. 2 with certain components and described with certain functionality herein, other embodiments of the multi-link communications system may include fewer or more components to implement the same, less, or more functionality. For example, in some embodiments, the multi-link communications system includes a single AP MLD with multiple STA MLDs, or multiple AP MLDs with more than one STA MLD. In some embodiments, the legacy STAs (non-UHR STAs) may associate with one of the APs affiliated with the AP MLD. In another example, although the multi-link communications system is shown in FIG. 2 as being connected in a certain topology, the network topology of the multi-link communications system is not limited to the topology shown in FIG. 2.

In the embodiment depicted in FIG. 2, the AP MLD 204 includes two APs in two links, implemented as APs 206-1 and 206-2. In such an embodiment, the APs may be AP1 206-1 and AP2 206-2. In some embodiments, a common part of the AP MLD 204 implements upper layer Media Access Control (MAC) functionalities common to all APs affiliated with the AP MLD 204 (e.g., association establishment, reordering of frames, etc.) and a link specific part of the AP MLD 204, i.e., the APs 206-1 and 206-2, implement upper layer MAC specific to a link and lower layer MAC functionalities (e.g., beaconing, backoff, frame transmission, frame reception, etc.). The APs 206-1 and 206-2 may be implemented in hardware (e.g., circuits), software, firmware, or a combination thereof. The APs 206-1 and 206-2 may be fully or partially implemented as an integrated circuit (IC) device. In some embodiments, the APs 206-1 and 206-2 may be wireless APs compatible with at least one WLAN communications protocol (e.g., at least one IEEE 802.11 protocol). For example, the APs 206-1 and 206-2 may be wireless APs compatible with an IEEE 802.11bn protocol. In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP 1 206-1 and/or AP 2 106-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received physical layer (PHY) protocol data units (PPDUs) through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1 or 206-2 of the AP MLD 204 may operate in a different BSS operating channel. For example, AP1 206-1 may operate in a 320 MHz (one million hertz) BSS operating channel at 6 Gigahertz (GHz) band and AP2 206-2 may operate in a 160 MHz BSS operating channel at 5 GHz band. Although the AP MLD 204 is shown in FIG. 2 as including two APs, other embodiments of the AP MLD 204 may include more than two APs or only one AP.

In the embodiment depicted in FIG. 2, the non-AP STA multi-link device, implemented as STA MLD 208, includes STAs non-AP STAs 210-1 and 210-2 on two links. In such an embodiment, the non-AP STAs may be STA1 210-1 and STA2 210-2. The STAs 210-1 and 210-2 may be implemented in hardware (e.g., circuits), software, firmware, or a combination thereof. The STAs 210-1 and 210-2 may be fully or partially implemented as an IC device. In some embodiments, the non-AP STAs 210-1 and 210-2 are part of the STA MLD 208, such that the STA MLD may be a communications device that wirelessly connects to a wireless AP MLD. For example, the STA MLD 208 may be implemented in a laptop, a desktop personal computer (PC), a mobile phone, or other communications device that supports at least one WLAN communications protocol. In some embodiments, the non-AP STA MLD 208 is a communications device compatible with at least one IEEE 802.11 protocol (e.g., an IEEE 802.11 bn protocol, an IEEE 802.11be protocol, an IEEE 802.11ax protocol, or an IEEE 802.11ac protocol). In some embodiments, the STA MLD 208 implements a common MAC data service interface and the non-AP STAs 210-1 and 210-2 implement a lower layer MAC data service interface.

In some embodiments, the AP MLD 204 and/or the STA MLD 208 may identify which communication links support multi-link operation during a multi-link operation setup phase and/or exchanges information regarding multi-link capabilities during the multi-link operation setup phase. In some embodiments, each of the non-AP STAs 210-1 and 210-2 of the STA MLD 208 may operate in a different frequency band. For example, the non-AP STA 210-1 may operate in the 2.4 GHz frequency band and the non-AP STA 210-2 may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received PPDUs through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 2, the STA MLD 208 communicates with the AP MLD 204 via two communication links, e.g., link 1 202-1 and link 2 202-2. For example, each of the non-AP STAs 210-1 or 210-2 communicates with an AP 206-1 or 206-2 via corresponding communication links 202-1 or 202-2. In an embodiment, a communication link (e.g., link 1 202-1 or link 2 202-2) may include a BSS operating channel established by an AP (e.g., AP 1 206-1 or AP 2 206-2) that features multiple 20 MHz channels used to transmit frames (e.g., data frames, beacon frames, management frames other than beacon frames, etc. in Physical Layer Protocol Data Units (PPDUs)) between a first wireless device (e.g., an AP, an AP MLD, an STA, or an STA MLD) and a second wireless device (e.g., an AP, an AP MLD, an STA, or an STA MLD). In some embodiments, a 20 MHz channel covered by the BSS operating channel may be a punctured 20 MHz channel or an unpunctured 20 MHz channel. Although the STA MLD 208 is shown in FIG. 2 as including two non-AP STAs, other embodiments of the STA MLD 208 may include one non-AP STA or more than two non-AP STAs. In addition, although the AP MLD 204 communicates (e.g., wirelessly communicates) with the STA MLD 208 via the communications links 202-1 and 202-2, in other embodiments, the AP MLD 204 may communicate (e.g., wirelessly communicate) with the STA MLD 208 via more than two communication links or less than two communication links.

In some embodiments, a first MLD, e.g., an AP MLD or non-AP MLD (STA MLD), may transmit MLD-level management frames in a multi-link operation with a second MLD, e.g., STA MLD or AP MLD, to coordinate the multi-link operation between the first MLD and the second MLD. As an example, a management frame may be a frame for Traffic Identifier (TID)-to-link mapping negotiation, a (Re)Association Request frame, a (Re)Association Response frame, a Disassociation frame, an Authentication frame, and/or a Block Acknowledgement (Ack) (BA) Action frame (Action frame for BA negotiation), etc. In some embodiments, an AP/STA of a first MLD may transmit link-level management frames to a STA/AP of a second MLD. In some embodiments, one or more link-level management frames may be transmitted via a cross-link transmission (e.g., according to an IEEE 802.11bn communication protocol). As an example, a cross-link management frame transmission may involve a management frame being transmitted and/or received on one link (e.g., the link 1202-1) while carrying information of another link (e.g., the link 2 202-2). In some embodiments, a management frame is transmitted on any link (e.g., at least one of two links or at least one of multiple links) between a first MLD (e.g., the AP MLD 204) and a second MLD (e.g., the STA MLD 208). As an example, a management frame may be transmitted between a first MLD and a second MLD on any link (e.g., at least one of two links or at least one of multiple links) associated with the first MLD and the second MLD.

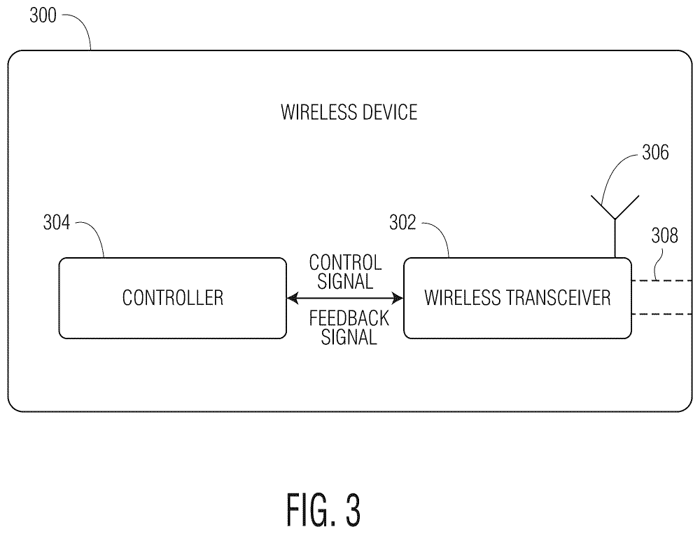

FIG. 3 depicts a wireless device 300 in accordance with example embodiments. The wireless device 300 can be used in the wireless communications system 100 depicted in FIG. 1 and/or the multi-link communications system 200 depicted in FIG. 2 for each link independently. For example, the wireless device 300 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 3, the wireless device 300 includes a wireless transceiver 302, a controller 304 operably connected to the wireless transceiver, and at least one antenna 306 operably connected to the wireless transceiver. In some embodiments, the wireless device 300 may include at least one optional network port 308 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 300 includes multiple transceivers. The controller may be configured to control the wireless transceiver (e.g., by generating a control signal) to process PPDUs received through the antenna and/or the network port and/or to generate outgoing PPDUs to be transmitted through the antenna and/or the network port. In some embodiments, the wireless transceiver transmits one or more feedback signals to the controller. In some embodiments, the controller is implemented within a processor, such as a microcontroller, a host processor, a host, a DSP, or a CPU. In some embodiments, the wireless transceiver 302 is implemented in hardware (e.g., circuits), software, firmware, or a combination thereof. The antenna may be any suitable type of antenna. For example, the antenna may be an induction type antenna such as a loop antenna or any other suitable type of induction type antenna. However, the antenna is not limited to an induction type antenna. The network port may be any suitable type of port.

In accordance with example embodiments, the controller 304 is configured to store Enhanced Distributed Channel Access (EDCA) backoff parameters when enabling a prioritized EDCA (P-EDCA) channel access (e.g., of a wireless channel/medium), for example, for low latency (LL) access category (AC), the wireless transceiver 302 is configured to perform the P-EDCA channel access by wirelessly transmitting a control frame (e.g., onto the wireless channel/medium) using P-EDCA parameters, for example, through the at least one antenna 306, and the controller 304 is further configured to resume an EDCA backoff procedure (e.g., to access the wireless channel/medium) using the stored EDCA backoff parameters when a certain condition is met.

Compared to a standard EDCA in which high-priority traffic may get delayed by retransmission and the other high-priority/low-priority users, prioritized EDCA channel access or prioritized EDCA allows the retransmission of the high-priority/low-latency (LL) frames to use the high-priority EDCA parameters instead of doubled contention window (CW). In some embodiments, in prioritized EDCA channel access or prioritized EDCA, different traffic types (e.g., voice, video, best effort, background) are assigned various retransmission rules to the wireless channel/medium. For example, voice (AC_VO, AC standing for access category, VO standing for voice) traffic may be assigned higher priority for the retransmitted voice frames and video frames (LL frames) than retransmitted video frames, best effort frames and the retransmitted background frames, for example, through shorter backoff times (Contention Window (CW) minimum/maximum (min/max)) and quicker channel access for the retransmitted low latency frames, ensuring lower latency for delay sensitive voice and video applications even when retransmission happens. In IEEE 802.11baseline, voice traffic/data (access category_voice (AC_VO)) is assigned the highest priority (smallest CWmin/max, shortest arbitration interframe space number (AIFSN) for real-time audio, video traffic/data (access category_video (AC_VI)) is assigned the second highest priority for video streams, best effort traffic/data (access category_best effort (AC_BE)) is the default traffic and is assigned a lower priority, and background traffic/data (access category_background (AC_BK)) is assigned the lowest priority for non-critical data. For example, lower values of CW mean shorter waiting time (e.g., Voice uses CWmin=3, CWmax=7), while higher values of CW mean longer waiting time. In another example, higher priority traffic/data, such as, voice and video traffic/data, is assigned shorter Arbitration Interframe Space (AIFS) values (e.g., AIFSN=2 for VO/VI), allowing a quicker wireless channel access. When a frame of any access category (AC) is retransmitted, the contention window (CW) is doubled until the CWmax of the related AC. In some embodiments, under P-EDCA, the retransmitted low latency frames (e.g. AC_VO frames) are transmitted use the CW per P-EDCA parameter set that is not doubled for the medium contention. In some embodiments, the P-EDCA is also applied to video frames (AC_VI frames), i.e., P-EDCA is applied to the video frames that are treated as LL frames.

In some embodiments, the wireless device 300 includes a non-access point (AP) station (STA) or an AP. In some embodiments, the P-EDCA parameters includes a P-EDCA parameter set for defer signal transmission. In some embodiments, the P-EDCA parameter set for defer signal transmission includes an arbitration inter-frame space number (AIFSN), a contention window (CW), and a defer signal retry counter. In some embodiments, the P-EDCA parameters include a P-EDCA parameter set for request to send (RTS) transmission that follows defer signal transmission. In some embodiments, the P-EDCA parameter set for RTS transmission includes an arbitration inter-frame space number (AIFSN) and a contention window (CW). In some embodiments, the P-EDCA parameters include a P-EDCA parameter set for request to send (RTS) transmission that follows defer signal transmission. In some embodiments, the P-EDCA parameter set for RTS transmission includes an arbitration inter-frame space number (AIFSN) and a contention window (CW). In some embodiments, the wireless transceiver 302 is further configured to retry the P-ECDA channel access until the certain condition is met when the P-EDCA channel access is not successful. In some embodiments, when the certain condition is met, a regular EDCA procedure is resumed. In some embodiments, the certain condition includes at least one of P-EDCA retrial reaches a predetermined limit; an LL AC frame transmission under the P-EDCA channel access is successful; the P-EDCA channel access is disabled by an AP's announcement; no buffered unit in a P-EDCA queue; and an LL data frame under retransmission is discarded because a life time or a delay bound of the LL data frame is reached. In some embodiments, the predetermined limit is a defer signal (DS) retry limit. In some embodiments, a CW of regular EDCA for LL AC is set to CWₘᵢₙᵢₘᵤₘ if the LL AC frame transmission under the P-EDCA channel access is successful. In some embodiments, a CW of regular EDCA for LL AC is set to a smaller value of CWₘₐₓᵢₘᵤₘ[AC] and 2^{QSRC[AC]}×(CWₘᵢₙᵢₘᵤₘ[AC]+1)−1) if the P-EDCA retrial reaches the predetermined limit.

In some embodiments, the controller 304 performs a backoff procedure (e.g., a P-EDCA backoff procedure on top of EDCA procedure) to reduce retransmission delay of LL frames by implementing a waiting period before the wireless device 300 (e.g., the wireless transceiver 302) attempts to retransmit the LL frames, with parameters that can be adjusted, for example, based on channel conditions and historical usage metrics.

In some embodiments, the wireless device 300 includes a non-access point (AP) station (STA). In some embodiments, the wireless device 300 includes a non-access point (AP) station (STA) and an AP.

In some embodiments, the wireless transceiver 302 is further configured to use the P-ECDA channel access for the retransmission up to a predetermined number of times when the P-EDCA channel access is not successful.

In some embodiments, the wireless transceiver 302 is further configured to use the P-ECDA channel access for the retransmission with updated P-EDCA parameters other than the doubled CW.

In some embodiments, low latency traffic is allowed during the P-EDCA channel access. In some embodiments, low latency traffic includes AC_VO traffic only. In some embodiments, low latency traffic includes AC_VI traffic and AC_VO traffic.

In some embodiments, the control frame includes a defer signal to reserve the wireless medium for frame retransmission by using the P-EDCA parameters without doubled CW.

In some embodiments, the defer signal includes a clear to send (CTS) frame.

In some embodiments, the P-EDCA parameters include a P-EDCA parameter set, which includes at least one of a P-EDCA retry count value, a P-EDCA contention window value instead of the doubled CW, and a backoff counter value selected per the P-EDCA contention window value.

In some embodiments, the P-EDCA parameters include P-EDCA parameters set I of a P-EDCA arbitration interframe space number for defer signal (DS) transmission(AIFSN[DS]) and a P-EDCA contention window value for defer signal (CW[DS]), DSRC (defer signal retry count) and P-EDCA parameters set II of AIFSN[P-AC] and CW[P-AC] for RTS transmission following the defer signal.

In some embodiments, when the certain condition happens/is met, a STA/AP that enables P-EDCA uses P-EDCA procedure to transmit the low latency frames. In some embodiments, the certain condition includes the number of an LL frame retransmission reaches a threshold, and no event to suspend P-EDCA procedure. In some embodiments, when the certain condition happens/is met, a STA/AP that is using the P-EDCA procedure for LL frame retransmission switches back to use EDCA procedure. In some embodiments, the certain condition includes at least one of P-EDCA retrial reaches a predetermined limit, the P-EDCA channel access is successful, the P-EDCA channel access is disabled by an AP's announcement, or no buffered unit in a P-EDCA queue, or a low latency data frame waiting for the retransmission is discarded because a life time or a delay bound of the low latency data frame is reached.

In some embodiments, the wireless transceiver 302 is further configured to wirelessly transmit a defer signal (DS), e.g., clear to send (CTS) frame, through P-EDCA parameters set I (AIFSN[DS], CW[DS], DS retry counter (DSRC)) to transmit CTS for the wireless medium reservation before wirelessly retransmitting a LL data frame through the backoff per P-EDCA parameters set II (CW[P-AC], AIFSN[P-AC]).

In some embodiments, the wireless device 300 is compatible with an Institute of Electrical and Electronics Engineers (IEEE) 802.11 protocol.

In some embodiments, a non-AP wireless station (STA) (e.g., the wireless device 300) and/or an AP include a controller (e.g., the controller 304) configured to store EDCA backoff parameters when enabling a prioritized EDCA (P-EDCA) channel access and a wireless transceiver (e.g., the wireless transceiver 302) configured to perform the P-EDCA channel access by wirelessly transmitting a control frame to reserve the wireless medium by using P-EDCA parameter set I for transmitting the defer signal and using P-EDCA parameter set II to contend the medium for transmitting RTS before the retransmitted LL frame, where P-EDCA parameter set I includes AIFSN[DS] CW[DS] and a DSRC, where the controller (e.g., the controller 304) is further configured to resume an EDCA backoff procedure using the stored EDCA backoff parameters when a certain condition is met.

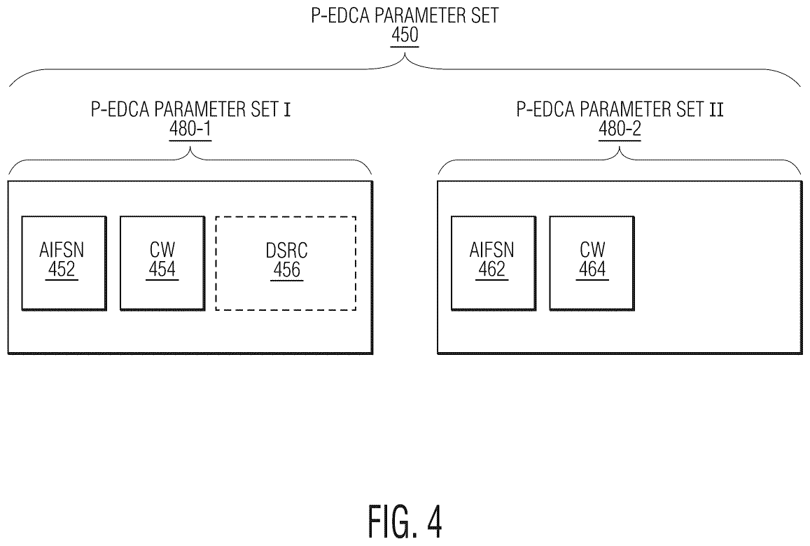

FIG. 4 illustrates a P-EDCA parameter set 450 in accordance with example embodiments. The P-EDCA EDCA parameter set 450 illustrated in FIG. 4 can be used for communications by the STA/AP in the wireless communications system 100 depicted in FIG. 1, the APs 206-1, 206-2, 206-3 depicted in FIG. 2, the STAs 210-1, 210-2, 210-3 depicted in FIG. 2, and/or the wireless device 300 depicted in FIG. 3. In the embodiment depicted in FIG. 4, the P-EDCA EDCA parameter set 450 includes P-EDCA EDCA parameter set I 480-1 with an AIFSN[DS] 452, a CW[DS] 454, and an optional DS Retry Count (DSRC) 456 for the defer signal transmission, and P-EDCA EDCA parameter set II 480-2 with AIFSN[P-AC] 462, CW[P-AC] 464 for the backoff in order to retransmit the LL frames. In some embodiments, an AP announces the P-EDCA EDCA parameter set 450 to a wireless device (e.g., the wireless device 300 depicted in FIG. 3).

In some implementations, to define prioritized Enhanced Distributed Channel Access (P-EDCA) in Ultra High Reliability (UHR) where a STA/AP with low latency traffic's retransmission may be allowed, based on various conditions, to send a defer signal (e.g., clear to send (CTS) frame or request to send (RTS)) to start a protected short contention for pending low latency retransmission frames without doubling the CW. However, conditions to be allowed to send a defer signal need to be determined. In some implementations, a STA in P-EDCA always use RTS/CTS (request to send/clear to send) as initial frame exchange for the retransmission of the LL frames after the defer signal transmission. However, access parameters (e.g., Arbitration Inter-Frame Space Number (AIFSN), contention window (CW), and expansion rules) used to transmit a defer signal need to be determined. For example, the retry count to trigger P-EDCA procedure for transmitting defer signal needs to be determined and contention parameters for determine when to transmit the defer signal need to be determined. The STAs that transmitted a defer signal but did not win the protected short contention may initiate a new retry. Low Latency traffic can be treated as AC_VO traffic. Other cases need to be determined. No new synchronization requirement may be on STA side. There is a need to provide control on the degree of collisions that may occur while using P-EDCA and, allows for autonomous randomness or/and controlled by an AP.

In some implementations, a CTS frame can be used for the defer signal to perform prioritized EDCA channel access for low latency traffic. In addition, a STA/AP in P-EDCA may always use RTS/CTS as initial frame exchange for the retransmission of the LL frames after the defer signal transmission. Following frame exchange sequences for P-EDCA (CTS (Defer Signal (DS))->RTS->CTS->low latency (LL) Data retransmission) can be considered. CTS (DS) transmission may be at the end of a transmit opportunity (TXOP). Channel access parameters for CTS DS transmission (e.g., AIFSN[DS], CW[DS], DSRC) can be defined as some default values (e.g., AIFSN[DS]=2, CW[DS]=0, DS retry limit for DSRC related operation=2) if the AP does not announce such values or the values of AIFSN[DS], CWmin[DS] and CWmax[DS] that define a value set from which the value of CW[DS] is selected, DS retry limit announced by the AP. A RTS can be transmitted during the short contention period. P-EDCA parameter set II (e.g., CW[P-AC] whose value is selected from the value set defined by [CWmin[P-AC], CWmax[P-AC]], AIFSN[P-AC], etc.) for P-EDCA RTS transmitter (TX) can be announced by an AP or can be the default values if the AP does not announce the P-EDCA parameter set II. If a CTS solicited by RTS is received, LL data can be retransmitted. If a CTS is not received during a short contention period, a CTS DS and an RTS can be retransmitted. If an RTS is not transmitted during the short contention period, a CTS DS and an RTS can be retransmitted. If P-EDCA is successful, the regular EDCA backoff is resumed. If P-EDCA access is not successful (e.g., RTS is not transmitted or CTS is not received in response to the RTS), retrial of P-EDCA procedure and the related channel access parameters needs to be defined.

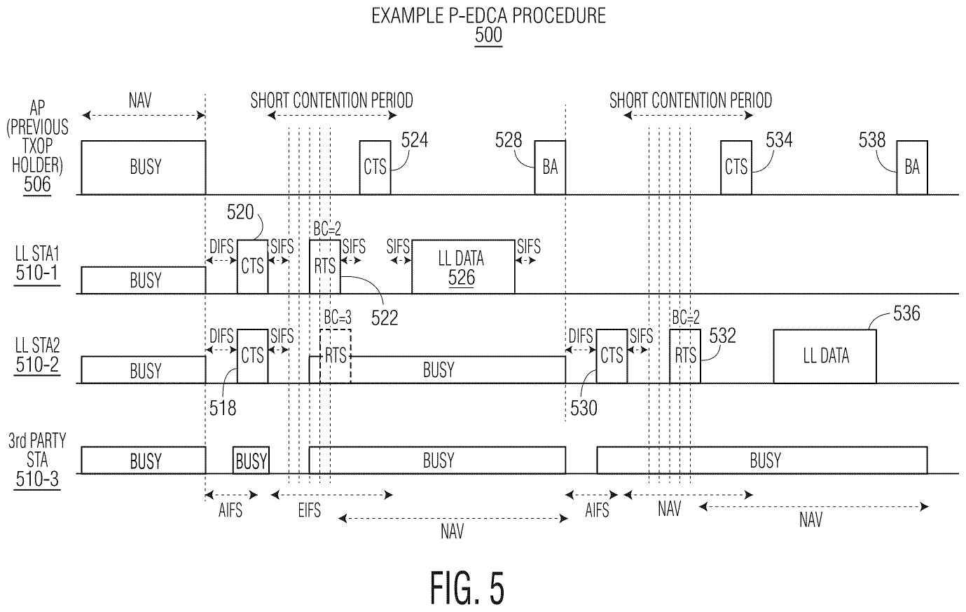

FIG. 5 shows an example P-EDCA procedure 500. In the example P-EDCA procedure 500, an AP (previous TXOP holder) 506 communicates with a low latency (LL) station 510-1 (STA1), a LL station 510-2 (STA2), and a third party station (STA) 510-3. As shown in FIG. 5, a frame exchange sequence of CTS 520->RTS 522->CTS 524->low latency (LL) Data 526 is conducted. A block acknowledgement (BA) 528 can be transmitted afterward. Subsequently, a frame exchange sequence of CTS 530->RTS 532->CTS 534->low latency (LL) Data 536 is conducted. A BA 538 can be transmitted afterward. CTS transmission may be at the end of a TXOP by an LL STA if the switching to P-EDCA procedure instead of EDCA procedure is triggered, e.g., the retransmission number of a low latency frame is higher/more than the threshold. Channel access parameter set I for CTS transmission (e.g., AIFSN[DS], CW[CW], QSRC) can be defined as some default values (e.g., AIFSN[DS]=2, CW[DS]=0) or the values announced by the AP (e.g., AIFSN[DS]=2, CW[CW]=2). The RTS 522 or 532 can be transmitted during the short contention period after the backoff per P-EDCA parameter set II. P-EDCA parameter set II (e.g., AIFSN[P-AC], CW[P-AC] that has a value selected from the value set of [CWmin[P-AC], CWmax[P-AC]], AIFSN[P-AC], etc.) for P-EDCA RTS transmitter (TX) can be announced by an AP or the default values if the AP does not announce such values. If a CTS solicited by RTS is received, LL data can be transmitted. If a CTS (e.g., a CTS 518) is not received during the short contention period, a CTS (e.g., the CTS 530) and an RTS (e.g., the RTS 532) can be retransmitted. If an RTS is not transmitted during the short contention period, a CTS (e.g., the CTS 530) and an RTS (e.g., the RTS 532) can be retransmitted through the defer signal CTS transmission procedure per P-EDCA parameter set I and RTS transmission procedure per P-EDCA parameter set II. If P-EDCA is successful, the regular EDCA backoff is resumed. If P-EDCA access is not successful (e.g., RTS is not transmitted or CTS is not received in response to the RTS), retrial of P-EDCA procedure and the related channel access parameters needs to be defined.

In some embodiments, P-EDCA parameters can be defined as default values and/or they can be announced by an AP. In some embodiments, P-EDCA parameter set II can be same as the EDCA parameters for the corresponding access category (AC) (e.g., AC_VO and/or AC_VI) unless an AP announces separate or different P-EDCA parameter set II for the AC in an individually addressed management frame (e.g., a Stream Classification Service (SCS) Response frame) or in a broadcast management frame (e.g., a beacon). In some embodiments, P-EDCA parameter set II for AC_VI are the same as P-EDCA parameter set of AC_VO such that only one P-EDCA parameter set II is announced by an AP. In some embodiments, P-EDCA parameter set II for AC_VI can be different from P-EDCA parameter set II for the AC_VO and announced separately by the AP.

In some embodiments, before initiating the P-EDCA channel access, a STA may store regular EDCA backoff information to use when resuming the regular EDCA backoff from the P-EDCA channel access.

In some embodiments, EDCA backoff parameters can be updated when resuming the regular EDCA procedure from the P-EDCA channel access. In some embodiments, the CW of the regular EDCA procedure is set based on whether the retransmitted LL frame is transmitted correctly or not. If the retransmitted LL frame is successfully transmitted, the related CW is set to CWmin and QSRC is set to 0. If the retransmitted LL frame is not successfully transmitted, the related CW is doubled and QSRC is increased by 1.

Some implementations of EDCA backoff parameters and P-EDCA channel access, for example, by the wireless communications system 100 depicted in FIG. 1, the multi-link (ML) communications system 200 depicted in FIG. 2, and/or the wireless device 300 depicted in FIG. 3 are described.

In some embodiments, conditions to enable the P-EDCA channel access can be defined as one or more of the followings:
a STA capable of the P-EDCA has a certain number of retry count for a specific access category, such as, AC_VO, AC_VI, etc. (e.g., Quality of Service STA Retry Count (QSRC)[VO]=To be determined (TBD), TBD can be 0, 1, or 2) (one variant is that the specific category is AC_VO only);
a STA capable of the P-EDCA has a certain number of retry count for a specific TID (Traffic Identifier) mapped to a high priority AC, such as, AC_VO, AC_VI, etc. (e.g., QSRC[TID]=TBD. TBD can be 0, 1, or 2);
an AP announces the enablement of P-EDCA channel access through an individually addressed management frame (e.g., a SCS Response) and/or a broadcast management frame (e.g., a beacon or other UHR broadcast management frame) (the enablement/disablement of the P-EDCA channel access can be indicated with one or more specific P-EDCA parameter value(s) (e.g., P-EDCA CW[P-AC]=a, P-EDCA AIFSN[P-AC]=b, P-EDCA CW[DS]=c, P-EDCA AIFSN[DS]=d, DSRC limit, etc.) or with an explicit indication indicating whether it is enabled or not);
if a certain timer (e.g., P-EDCA suspension/disabling timer) operates, the timer does not run or expires.

In some embodiments, when the condition to enable the P-EDCA channel access is met, e.g., when the number of an LL frame's retransmission reaches a threshold, a P-EDCA STA may suspend its regular EDCA channel access and it may perform the P-EDCA channel access (e.g., by transmitting a CTS Defer Signal frame).

In some embodiments, before initiating the P-EDCA channel access, the STA may store the regular EDCA backoff information (e.g., the current QoS Short Retry Counter (QSRC), CW, backoff counter, etc.) to resume the regular EDCA channel access when the P-EDCA channel access ends (regardless of P-EDCA success/failure) or when the P-EDCA is disabled/suspended.

In some embodiments, P-EDCA channel access can be carried only for one or more predefined (and/or pre-negotiated) TID/AC (e.g., P-EDCA TID/AC). In some embodiments, for transmitting a data frame other than the P-EDCA TID/AC, a STA can perform the regular EDCA channel access while performing the P-EDCA channel access for the P-EDCA TID/AC.

Some implementations of resuming the regular EDCA backoff procedure from the P-EDCA channel access, for example, by the wireless communications system 100 depicted in FIG. 1, the multi-link (ML) communications system 200 depicted in FIG. 2, and/or the wireless device 300 depicted in FIG. 3 are described.

In some embodiments, if/when a certain condition is met, the regular EDCA can be resumed from the P-EDCA.

In some embodiments, the condition can be one of the followings:
P-EDCA retrial reaches the predetermined limit (e.g., P-EDCA failure for a certain number of times retries up to predefined in the spec, announced by the AP, or negotiated between the STA and the AP, such as, the retrial limit=2 or 3);
the P-EDCA channel access is successful (e.g., successful transmission of the data frame buffered to the queue of the P-EDCA AC/Traffic Identifier (TID), or successful transmission of the data frame of the P-EDCA AC/TID that requires the retransmission);
P-EDCA is disabled by AP's announcement;
no buffered unit(s) (BU(s)) in the P-EDCA TID/AC queue (e.g., due to successful transmission of the BU(s) in other way such as uplink (UL) trigger-based transmission, through the different link in the MLD, etc.);

the data frame of the P-EDCA AC/TID that requires the retransmission is discarded because the life-time or the delay bound of the frame is reached.

In some embodiments, EDCA backoff parameters (e.g., QSRC, CW, etc.) can be updated as one of the following options when resuming the regular EDCA backoff procedure from the P-EDCA:
Option 1: parameters (e.g., QSRC, CW) unchanged (this option can be applied when the P-EDCA is disabled by an AP's announcement or when the P-EDCA retrial reached the retrial limit);

Option 2: QSRC increased by 1 and CW doubled (this option can be applied when the P-EDCA retrial reached the retrial limit);

Option 3: parameters reset (e.g., QSRC=0, CW=CWmin) (this option can be applied when the P-EDCA is successful or when there is no buffered BU(s) in the P-EDCA TID/AC queue.)

In some embodiments, P-EDCA can be enabled when the condition to enable the P-EDCA channel access is met as described above.

Some implementations of P-EDCA retrial, for example, by the wireless communications system 100 depicted in FIG. 1, the multi-link (ML) communications system 200 depicted in FIG. 2, and/or the wireless device 300 depicted in FIG. 3 are described.

In some embodiments, when the P-EDCA channel access is not successful, a STA can do or perform one of the followings options:
Option 1: retry the P-EDCA channel access for defer signal transmission using P-EDCA parameter set I up to a P-EDCA retry limit (e.g., 2 or 3) (the transmission procedure of defer signal by using the P-EDCA parameter set I (CW[DS] that is one of value set [CWmin[DS], CWmax[DS]], AIFSN[DS]DSRC are applied);
Option 2: resume the regular EDCA backoff procedure with the following options,
   Option 2-1: CW doubled and QSRC increased by 1,
   Option 2-2: CW and QSRC unchanged,
   Option 2-3: CW and QSRC reset,
   Option 2-4: CW set to the lesser of CWmax[DS] and 2^{DSRC}×(CWmin[DS]+1)−1 and QSRC increased by 1.

In some embodiments, in one variant, if 1) a P-EDCA STA that transmitted an RTS frame after sending a CTS DS frame does not receive a CTS frame during the short contention period and 2) DSRC reaches the DSRC limit, the P-EDCA STA can perform the operation in Option 2. Otherwise, the STA can perform the operation in Option 1.

In some embodiments, in another variant, if P-EDCA retry fails and DSRC reaches the DSRC limit, regardless of the P-EDCA failure reason, the STA can perform the operation in Option 1.

In some embodiments, if/when P-EDCA retrial reaches the P-EDCA retry limit, the STA can perform the operation in Option 2.

Some implementations of P-EDCA parameter set, for example, by the wireless communications system 100 depicted in FIG. 1, the multi-link (ML) communications system 200 depicted in FIG. 2, and/or the wireless device 300 depicted in FIG. 3 are described.

In some embodiments, P-EDCA parameter set consists of:
P-EDCA parameter set I, which defines channel access parameters for CTS Defer Signal frame transmission and contains AIFSN[DS], CW[DS] (CW[DS] is a fixed value or any value from the value set of [CWmin[DS], CWmax[DS]]) and DSRC (DS Retry Count);
P-EDCA parameter set II, which defines channel access parameters for subsequent RTS frame (followed by Data frame) transmission after the CTS Defer Signal and contains AIFSN[P-AC] and CW[P-AC] (e.g., CW[AC] can be a fixed value or any value from the value set of [CWmin[P-AC], CWmax[P-AC]]).

In some embodiments, an AP may announce the P-EDCA parameter set along with the EDCA parameter set. In some embodiments, for more than one P-EDCA ACs (or TIDs) being enabled, one or more P-EDCA parameter sets can be announced by the AP (e.g., P-EDCA parameter set [VO], P-EDCA parameter set [VI], P-EDCA parameter set [TID], etc.) In some embodiments, a P-EDCA STA may perform P-EDCA channel access using the default P-EDCA parameter set or the P-EDCA parameter set announced by its associated AP.

In some embodiments, P-EDCA parameter set can be defined as:
P-EDCA parameter set I (for CTS DS Tx) including AIFSN[DS], CW[DS] (a fixed value or any value from the value set of [CWmin[DS], CWmax[DS]), and DSRC;
P-EDCA parameter set II (for subsequent RTS (or Data) Tx) including AIFSN[P-AC] and CW[P-AC] (a fixed value or any value from the value set of [CWmin[P-AC], CWmax[P-AC]]).

In some embodiments, AIFSN[DS] can be used as a default value or a value announced by the AP.

In some embodiments, AIFSN[DS] can be set to the same value for different TIDs/ACs (e.g., value 2 for both AC_VO and AC_VI) or different values for different TIDs/ACs (e.g., 2 for VO and 3 for VI), which can be announce by the AP.

In some embodiments, CW[DS] can be used as a default value or a value announced by the AP.

In some embodiments, CW[DS] can be set to the same value for different TIDs/ACs (e.g., value 0 for both AC_VO and AC_VI) or different values for different TIDs/ACs (e.g., 0 for AC_VO and 1 for AC_VI), which can be announce by the AP with the different set of parameters.

In some embodiments, CW[DS] can be set to a single value for P-EDCA initial trial and its retrial (e.g., CWmin[DS]=CWmax[DS]=0) or any value from the value set of [CWin[P-AC], CWmax[P-AC]] (e.g., CWmin[DS]=0, CWmax[DS]=1), which can be defined as default values or announced by the AP. In some embodiments, if/when DSRC is zero, CW[DS] shall be set to CWmin[DS]. Otherwise, CW[DS] shall be set to CWmax[DS].

In some embodiments, AIFSN[P-AC] and CW[P-AC] can be used as default values or values announced by the AP.

In some embodiments, in another variant, after switching to the regular EDCA procedure, the regular EDCA parameters for the corresponding LL AC (e.g., AIFSN and the current CW associated with the AC for the LL AC) can be resumed or updated. For example, if/when the frames are allowed to use P-EDCA, AIFSN for AC_VO can be set to AIFSN[AC_VO] and CW for AC_VO can be set to the lesser of CWmax[AC_VO] and 2^{QSRC[AC]}×(CWmin[AC]+1)−1).

In some embodiments, AIFSN LL ACs will be set per AIFSN[LL AC] in the regular EDCA parameter set.

In some embodiments, the same value of the CW[P-AC] can be used for P-EDCA initial trial and its retrial (e.g., CWmin[P-AC]=CWmax[P-AC]=7). In some embodiments, in another variant, different values (e.g., CWmin[P-AC]=3, CWmax[P-AC]=7) can be used for P-EDCA initial trial and its retrial

In some embodiments, the same CW[P-AC] can be set used for different TIDs/ACs (e.g., CWmin[P-VO]=CWmax[P-VI]=7 for both AC_VO and AC_VI). In some embodiments, in another variant, different values for different TIDs/ACs (e.g., CWmin[P-VO]=3 and CWmax[P-VO]=7, and CWmin[P-VI]=7 and CWmax[P-VI]=15), which can be announced by the AP with the different set of parameters. In some embodiments, if/when CWmin[P-AC] is not equal to CWmax[P-AC], CW[P-AC] shall be set to the lesser of CWmax[P-AC] and 2^{DSRC}×(CWmin[P-AC]+1)−1).

Some implementations of aggregation of other AC/TID in the P-EDCA TXOP, for example, by the wireless communications system 100 depicted in FIG. 1, the multi-link (ML) communications system 200 depicted in FIG. 2, and/or the wireless device 300 depicted in FIG. 3 are described.

In some embodiments, in a TXOP obtained by the P-EDCA channel access, a STA may transmit, in Option 1, only MAC Protocol Data Unit (MPDU) (s) for the P-EDCA TID/AC per the TXOP limit of the P-EDCA TID/AC.

In some embodiments, in a TXOP obtained by the P-EDCA channel access, a STA may transmit, in Option 2, MPDU(s) for the P-EDCA TID/AC and aggregated with MPDU(s) of other TID/AC under the certain restriction (e.g., with the P-EDCA TXOP limit, within the PPDU length limit, or with the TXOP limit associated with the corresponding AC, etc.). In some embodiments, the restriction can be announced by its associated AP (or negotiated between the AP and the STA) through an individually addressed management frame or a broadcast management frame.

In some embodiments, in a TXOP obtained by the P-EDCA channel access, a STA may transmit, in Option 3, MPDU(s) for the P-EDCA TID/AC and aggregated with Management MAC Protocol Data Unit(s) (MMPDU(s)) and/or QoS Null frame(s).

Some implementations of Triggering UL transmission of the P-EDCA TID by Trigger frame, for example, by the wireless communications system 100 depicted in FIG. 1, the multi-link (ML) communications system 200 depicted in FIG. 2, and/or the wireless device 300 depicted in FIG. 3 are described.

In some embodiments, through the SCS flow setup, a dedicated TID can be assigned to a high priority access category (e.g., AC_VO, AC_VI).

In some embodiments, if/when no SCS flow setup (negotiation), TIDs can be mapped to the same values of the User Priorities (UPs) that derive the corresponding ACs. For example, TID 1 and 2 can be mapped to AC_BK, TID 0and 3 can be mapped to AC_BE, TID 4 and 5 can be mapped to AC_VI, TID 6and 7 mapped to AC_VO.

In some embodiments, P-EDCA channel access is enabled for one or more high priority ACs (e.g., AC_VO only or both AC_VO and AC_VI) and the TIDs are mapped to the high priority ACs.

In some embodiments, an AP may transmit a trigger frame indicating a UL TID that is assigned to a specific AC through the SCS negotiation or that is mapped to an AC without the SCS negotiation, to trigger UL transmission for the buffered BUs for TID(s) of which priority is equal to or higher than the indicated TID. In some embodiments, the trigger frame can be the basic trigger frame to trigger transmission of the Uplink (UL) trigger-based (TB) PPDU from the STA or the multi-user (MU)-RTS TXS (TXOP sharing) trigger frame to share its TXOP with the STA.

In some embodiments, an AP may trigger UL transmission from a P-EDCA STA by transmitting a trigger frame indicating a TID that is mapped to the P-EDCA enabled AC (e.g., AC based P-EDCA enabling) or that is enabled for P-EDCA channel access (e.g., TID based P-EDCA enabling). In some embodiments, an AP may control the P-EDCA channel access load by triggering transmission of P-EDCA TID.

Some implementations of P-EDCA backoff parameter update, for example, by the wireless communications system 100 depicted in FIG. 1, the multi-link (ML) communications system 200 depicted in FIG. 2, and/or the wireless device 300 depicted in FIG. 3 are described.

In some embodiments, in a P-EDCA success case, DS Tx→RTS/CTS exchange→data frame Tx→acknowledgement Rx, all P-EDCA backoff parameters (e.g., DSRC set to 0, CW[DS] set to CWmin[DS], CW[P-AC]=CWmin[P-AC]) are reset and the regular EDCA backoff (e.g., with QSRC[AC] set to 0 and CW[AC] set to CWmin[AC]) resumes.

Some examples of P-EDCA failure cases are described as follows.

In some embodiments, a first P-EDCA failure case can be expressed as: DS Tx→no RTS TX. In some embodiments, if/when DSRC is less than the DS Retry Limit (or P-EDCA Retry Limit), DSRC shall be incremented by 1, otherwise, the regular EDCA backoff procedure resumes. In some embodiments, CW[LL AC] for regular EDCA procedure shall be set to:
Option1: left unchanged;
Option2: set to CWmax[LL CC];
Option3: set to the lesser of CWmax[LL CC] and 2^{DSRC}×(CWmin[LL CC]+1)−1.
   In some embodiments, CW[LL CC] and QSRC for regular EDCA procedure are left unchanged.
   In some embodiments, CW[DS] shall be set to:
Option1: left unchanged;
Option2: set to CWmax[DS];
Option3: set to the lesser of CWmax[DS] and 2^{DSRC}×(CWmin[DS]+1)−1;
Option4: set to CWmin[DS].

In some embodiments, CW[P-AC] and QSRC are left unchanged. In some embodiments, CW[P-AC] is set to CWmin[P-AC].

In some embodiments, a second P-EDCA failure case can be expressed as: DS Tx→RTS Tx→no CTS Rx. In some embodiments, if/when DSRC is less than the DS Retry Limit (or P-EDCA Retry Limit), DSRC shall be incremented by 1, otherwise, resume the regular EDCA backoff procedure. In some embodiments, CW[LL AC] for regular EDCA procedure with LL AC equal to P-AC shall be set to:
Option1: left unchanged;
Option2: set to CWmax[LL CC];
Option3: set to the lesser of CWmax[LL CC] and 2^{DSRC}×(CWmin[LL CC]+1)−1.

### In Some Embodiments, Cw[ds] Shall Be Set to:

Option1: CWmax[DS];
Option 2: the lesser of CWmax[DS] and 2^{DSRC}×(CWmin[DS]+1)−1.

In some embodiments, CW[P-AC] shall be set to the lesser of CWmax[P-AC] and 2^{DSRC}×(CWmin[P-AC]+1)−1). In some embodiments, CW[P-AC] shall be set to CWmin[P-AC]. In some embodiments, QSRC[AC] shall be
Option1: left unchanged;
Option 2: incremented by 1.

In some embodiments, a third P-EDCA failure case can be expressed as: DS Tx→RTS/CTS exchanges→data frame Tx→no acknowledgement Rx.

In some embodiments, in Option1, if/when DSRC is less than the DS Retry Limit (or P-EDCA Retry Limit), DSRC shall be incremented by 1, otherwise, resume the regular EDCA backoff procedure. In some embodiments, CW[LL AC] for regular EDCA procedure with LL AC equal to P-AC shall be set to:
Option1: left unchanged;
Option2: set to CWmax[LL CC];
Option 3: set to the lesser of CWmax[LL CC] and 2^{DSRC}×(CWmin[LL CC]+1)−1.

In some embodiments, CW[DS] shall be set to CWmax[DS] or the lesser of P-EDCA CWmax[DS] and 2^{DSRC}×(P-EDCA CWmin[DS]+1)−1. In some embodiments, CW[DS] shall be set to CWmin[DS]. In some embodiments, CW[P-AC] shall be set to the lesser of CWmax[P-AC] and 2^{DSRC}×(CWmin[P-AC]+1)−1). In some embodiments, CW[P-AC] shall be set to CWmin[P-AC]. In some embodiments, QSRC[AC] shall be set to left unchanged or incremented by 1 if QSRC[AC] is less than dot11ShortRetryLimit.

In some embodiments, in Option2, if/when DSRC is less than the DS Retry Limit (or P-EDCA Retry Limit), DSRC shall be incremented by 1, and otherwise, the regular EDCA backoff procedure resumes. In some embodiments, CW[DS] and CW[P-AC] shall be left unchanged. In some embodiments, QSRC[AC] shall be left unchanged or incremented by 1 if QSRC[AC] is less than dot11ShortRetryLimit.

In some embodiments, in Option3, all P-EDCA backoff parameters (e.g., DSRC set to 0, CW[DS] set to CWmin[DS], CW[P-AC]=CWmin[P-AC]) are reset and the regular EDCA backoff procedure (with QSRC[AC] and CW[AC] unchanged) resumes.

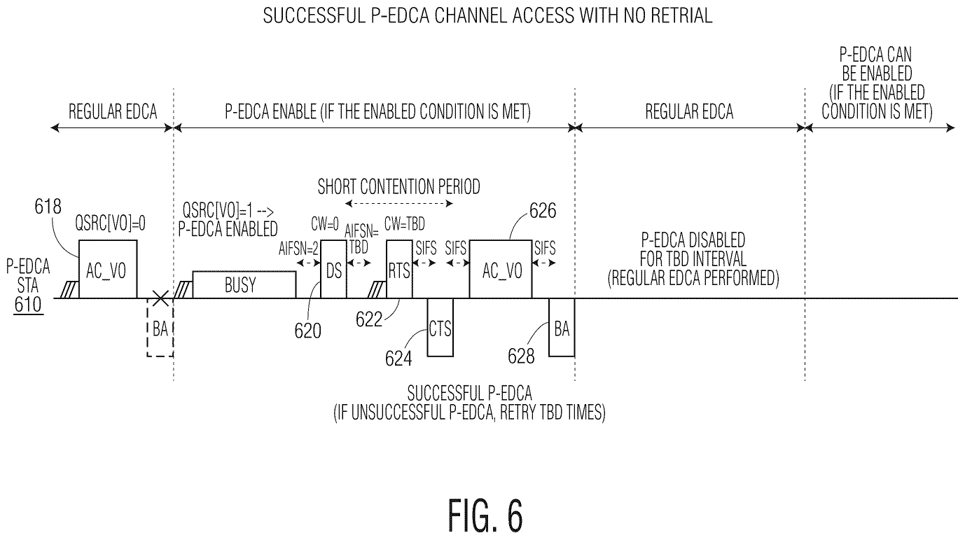

FIG. 6 shows a successful P-EDCA channel access with no retrial in accordance with example embodiments. As shown in FIG. 6, in regular EDCA channel access, after a backoff period, a P-EDCA station 610 transmits an AC_VO frame 618 with QSRC[VO]=0, for example, to an AP (not shown in FIG. 6). In some embodiments, no BA frame is received at the P-EDCA station 610.

Subsequently, QSRC[VO] is set to 1 and P-EDCA channel access to a wireless channel/medium is enabled for the P-EDCA station 610. Initially, the wireless channel/medium is determined to be busy, for example, by sending a PPDU in the wireless channel/medium after a backoff period and finding collision of the PPDU with other communications in the wireless channel/medium. Once the wireless channel/medium becomes available, after an Arbitration Inter-Frame Space Number (AIFSN) of 2, the P-EDCA station 610 transmits a DS 620 with a contention window (CW) of zero, for example, to an AP (not shown in FIG. 6). Subsequently, in a short contention period, after a certain number (to be determined (TBD)) of AIFSN, the P-EDCA station 610 transmits an RTS 622 with a certain (TBD) CW value after a backoff period, for example, to an AP (not shown in FIG. 6). After a Short Interframe Space (SIFS), the P-EDCA station 610 receives a CTS 624, for example, from an AP (not shown in FIG. 6). After an SIFS, the P-EDCA station 610 transmits an AC_VO frame 626, for example, to an AP (not shown in FIG. 6). After an SIFS, the P-EDCA station 610 receives a BA 628, for example, from an AP (not shown in FIG. 6).

Subsequently, P-EDCA channel access is disabled and regular EDCA channel access is enabled, for example, for a certain time period. After the certain time period, P-EDCA channel access can be enabled if/when one or more enabled conditions is met.

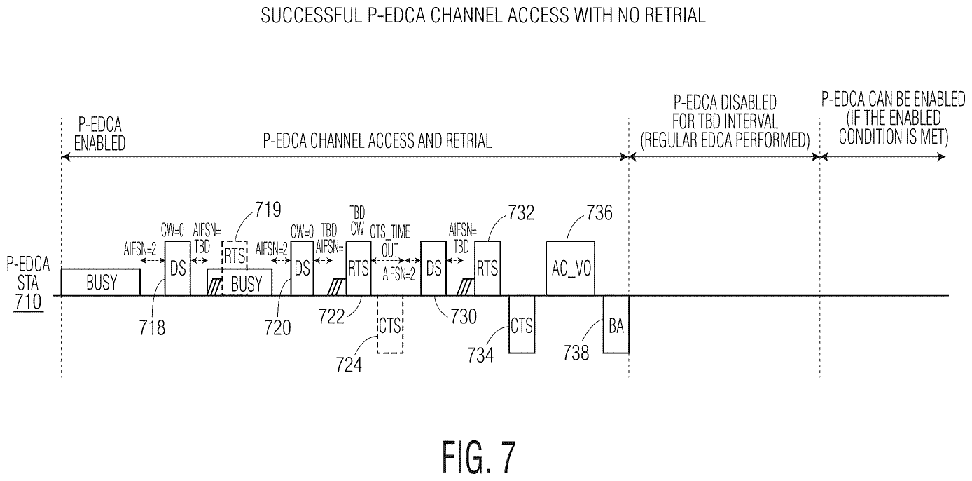

FIG. 7 shows a P-EDCA channel access with retrial in accordance with example embodiments. As shown in FIG. 7, P-EDCA channel access to a wireless channel/medium is enabled for a P-EDCA station 710. Initially, the wireless channel/medium is determined to be busy, for example, by sending a PPDU in the wireless channel/medium after a backoff period and finding collision of the PPDU with other communications in the wireless channel/medium. Once the wireless channel/medium becomes available, after an Arbitration Inter-Frame Space Number (AIFSN) of 2, the P-EDCA station 710 transmits a first DS 718 with a contention window (CW) of zero, for example, to an AP (not shown in FIG. 7). Subsequently, after a certain number (to be determined (TBD)) of AIFSN, the P-EDCA station 710 attempts to transmit an RTS 719 after a backoff period, for example, to an AP (not shown in FIG. 7), and finds a collision of the RTS 719 with other communications in the wireless channel/medium. Subsequently, after an AIFSN of 2, the P-EDCA station 710 transmits a DS 720 in a first DS retrial with a CW of zero, for example, to an AP (not shown in FIG. 7). Subsequently, after a certain number (to be determined (TBD)) of AIFSN, the P-EDCA station 710 transmits an RTS 722 with a certain (TBD) CW value after a backoff period, for example, to an AP (not shown in FIG. 7). After a CTS_timeout period, the P-EDCA station 610 fails to receive a CTS 724, for example, from an AP (not shown in FIG. 7). Subsequently, after an AIFSN of 2, the P-EDCA station 710 transmits a DS 730 in a second DS retrial, for example, to an AP (not shown in FIG. 7). Subsequently, after a certain number (to be determined (TBD)) of AIFSN, the P-EDCA station 710 transmits an RTS 732 with a certain (TBD) CW value after a backoff period, for example, to an AP (not shown in FIG. 7). After, for example, an SIFS, the P-EDCA station 710 receives a CTS 734, for example, from an AP (not shown in FIG. 7). After, for example, an SIFS, the P-EDCA station 710 transmits an AC_VO frame 736 to: for example, an AP (not shown in FIG. 7). After, for example, an SIFS, the P-EDCA station 710 receives a BA 928, for example, from an AP (not shown in FIG. 7).

Subsequently, P-EDCA channel access is disabled and regular EDCA channel access is enabled, for example, for a certain time period. After the certain time period, P-EDCA channel access can be enabled if/when one or more enabled conditions is met.

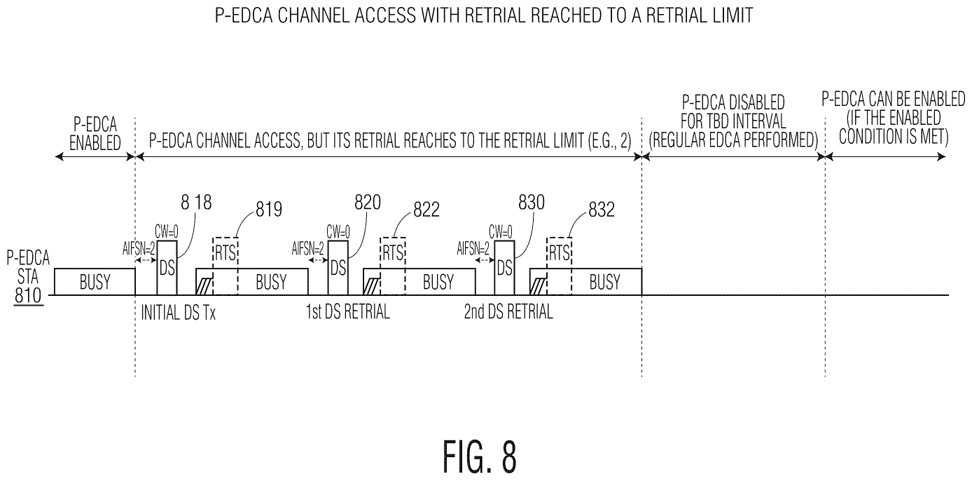

FIG. 8 shows a P-EDCA channel access with retrial reached to a retrial limit in accordance with example embodiments. As shown in FIG. 8, P-EDCA channel access to a wireless channel/medium is enabled for a P-EDCA station 810. Initially, the wireless channel/medium is determined to be busy, for example, by sending a PPDU in the wireless channel/medium after a backoff period and finding collision of the PPDU with other communications in the wireless channel/medium. Once the wireless channel/medium becomes available, after an Arbitration Inter-Frame Space Number (AIFSN) of 2, the P-EDCA station 810 transmits a first DS 818 with a contention window (CW) of zero, for example, to an AP (not shown in FIG. 8). Subsequently, for example, after a certain number (to be determined (TBD)) of AIFSN, the P-EDCA station 810 attempts to transmit an RTS 819 after a backoff period, for example, to an AP (not shown in FIG. 8), and finds a collision of the RTS 819 with other communications in the wireless channel/medium. Subsequently, after an AIFSN of 2, the P-EDCA station 810 transmits a DS 820 in a first DS retrial with a CW of zero, for example, to an AP (not shown in FIG. 8). Subsequently, for example, after a certain number (to be determined (TBD)) of AIFSN, the P-EDCA station 810 attempts to transmit an RTS 822 after a backoff period, for example, to an AP (not shown in FIG. 8), and finds a collision of the RTS 822 with other communications in the wireless channel/medium. Subsequently, after an AIFSN of 2, the P-EDCA station 810 transmits a DS 830 in a second DS retrial with a CW of zero, for example, to an AP (not shown in FIG. 8). Subsequently, for example, after a certain number (to be determined (TBD)) of AIFSN, the P-EDCA station 810 attempts to transmit an RTS 832 after a backoff period, for example, to an AP (not shown in FIG. 8), and finds a collision of the RTS 832 with other communications in the wireless channel/medium.

Subsequently, P-EDCA channel access is disabled and regular EDCA channel access is enabled, for example, for a certain time period. After the certain time period, P-EDCA channel access can be enabled if/when one or more enabled conditions is met.

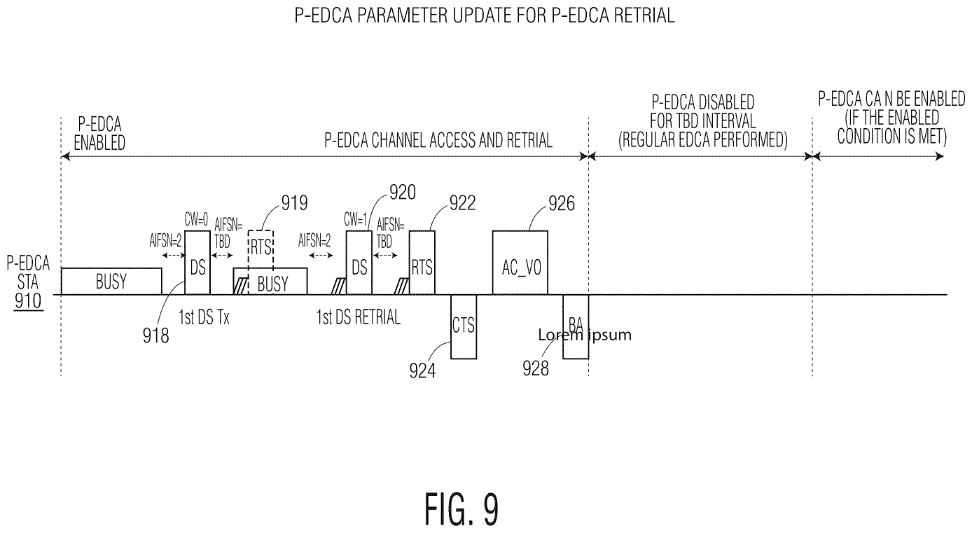

FIG. 9 shows a P-EDCA parameter update for P-EDCA retrial in accordance with example embodiments. As shown in FIG. 9, P-EDCA channel access to a wireless channel/medium is enabled for a P-EDCA station 910. Initially, the wireless channel/medium is determined to be busy, for example, by sending a PPDU in the wireless channel/medium after a backoff period and finding collision of the PPDU with other communications in the wireless channel/medium. Once the wireless channel/medium becomes available, after an Arbitration Inter-Frame Space Number (AIFSN) of 2, the P-EDCA station 910 transmits a first DS 918 with a CW of zero, for example, to an AP (not shown in FIG. 9). Subsequently, for example, after a certain number (to be determined (TBD)) of AIFSN, the P-EDCA station 910 attempts to transmit an RTS 919 after a backoff period, for example, to an AP (not shown in FIG. 9), and finds a collision of the RTS 919 with other communications in the wireless channel/medium. Subsequently, after an AIFSN of 2, the P-EDCA station 910 transmits a DS 920 in a first DS retrial with a CW of one, for example, to an AP (not shown in FIG. 9). Subsequently, after a certain number (to be determined (TBD)) of AIFSN, the P-EDCA station 910 transmits an RTS 922 with a certain (TBD) CW value after a backoff period, for example, to an AP (not shown in FIG. 9). After, for example, an SIFS, the P-EDCA station 910 receives a CTS 924, for example, from an AP (not shown in FIG. 9). After, for example, an SIFS, the P-EDCA station 910 transmits an AC_VO frame 926 to, for example, an AP (not shown in FIG. 9). After, for example, an SIFS, the P-EDCA station 910 receives a BA 928, for example, from an AP (not shown in FIG. 9).

Subsequently, P-EDCA channel access is disabled and regular EDCA channel access is enabled, for example, for a certain time period. After the certain time period, P-EDCA channel access can be enabled if/when one or more enabled conditions is met.

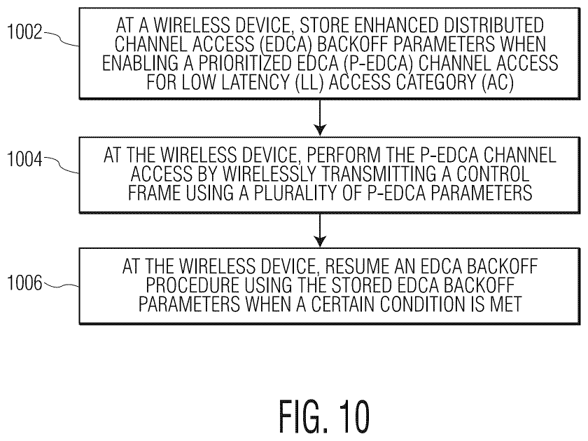

FIG. 10 is a process flow diagram of a method for wireless communications in accordance with example embodiments. At block 1002, at a wireless device, Enhanced Distributed Channel Access (EDCA) backoff parameters are stored when enabling a prioritized EDCA (P-EDCA) channel

access. At block 1004, at the wireless device, the P-EDCA channel access is performed by wirelessly transmitting a control frame using P-EDCA parameters. At block 1006, at the wireless device, an EDCA backoff procedure is resumed using the stored EDCA backoff parameters when a certain condition is met. In some embodiments, the wireless device includes a non-access point (AP) station

(STA) or an AP. In some embodiments, the P-EDCA parameters include a P-EDCA parameter set for defer signal transmission. In some embodiments, the P-EDCA parameter set for defer signal transmission includes an arbitration inter-frame space number (AIFSN), a contention window (CW), and a defer signal retry counter. In some embodiments, the P-EDCA parameters include a P-EDCA parameter set for request to send (RTS) transmission that follows defer signal transmission. In some embodiments, the P-EDCA parameter set for RTS transmission includes an arbitration inter-frame space number (AIFSN) and a contention window (CW). In some embodiments, the P-ECDA channel access is retried until the certain condition is met when the P-EDCA channel access is not successful. In some embodiments, the wireless device is compatible with an Institute of Electrical and Electronics Engineers (IEEE) 802.11 protocol. The wireless device may be the same as or similar to an embodiment of the STA 110-1, . . . , or 110-n depicted in FIG. 1, the STAs 210-1, 210-2 and/or the STA MLD 208 depicted in FIG. 2, and/or the wireless device 300 depicted in FIG. 3.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the disclosure may be implemented entirely in hardware or in an implementation containing both hardware and software elements. In embodiments which use software, the software may include but is not limited to firmware, resident software, microcode, etc.

Although specific embodiments of the disclosure have been described and illustrated, the disclosure is not to be limited to the specific forms or arrangements of parts so described and illustrated. The scope of the claims is to be defined by the claim language and their equivalents.

What is claimed is:

1. A wireless device comprising:
a controller configured to store a plurality of Enhanced Distributed Channel Access (EDCA) backoff parameters when enabling a prioritized EDCA (P-EDCA) channel access for low latency (LL) access category (AC); and
a wireless transceiver configured to perform the P-EDCA channel access by wirelessly transmitting a control frame using a plurality of P-EDCA parameters,
wherein the controller is further configured to resume an EDCA backoff procedure using the stored EDCA backoff parameters when a certain condition is met.

2. The wireless device of claim 1, wherein the wireless device comprises a non-access point (AP) station (STA) or an AP.

3. The wireless device of claim 1, wherein the P-EDCA parameters comprise a P-EDCA parameter set for defer signal transmission.

4. The wireless device of claim 3, wherein the P-EDCA parameter set for defer signal transmission comprises an arbitration inter-frame space number (AIFSN), a contention window (CW), and a defer signal retry counter.

5. The wireless device of claim 1, wherein the P-EDCA parameters comprise a P-EDCA parameter set for request to send (RTS) transmission that follows defer signal transmission.

6. The wireless device of claim 5, wherein the P-EDCA parameter set for RTS transmission comprises an arbitration inter-frame space number (AIFSN) and a contention window (CW).

7. The wireless device of claim 4, wherein the wireless transceiver is further configured to retry the P-ECDA channel access until the certain condition is met when the P-EDCA channel access is not successful.

8. The wireless device of claim 1, wherein when the certain condition is met, a regular EDCA procedure is resumed.

9. The wireless device of claim 7, wherein the certain condition comprises at least one of:
P-EDCA retrial reaches a predetermined limit;
an LL AC frame transmission under the P-EDCA channel access is successful;
the P-EDCA channel access is disabled by an AP's announcement;
no buffered unit in a P-EDCA queue; and
an LL data frame under retransmission is discarded because a life time or a delay bound of the LL data frame is reached.

10. The wireless device of claim 9, wherein the predetermined limit is a defer signal (DS) retry limit.

11. The wireless device of claim 9, wherein a CW of regular EDCA for LL AC is set to CWminimum if the LL AC frame transmission under the P-EDCA channel access is successful.

12. The wireless device of claim 9, wherein a CW of regular EDCA for LL AC is set to a smaller value of CWmaximum[AC] and 2^{QSRC[AC]}×(CWminimum[AC]+1)−1) if the P-EDCA retrial reaches the predetermined limit.

13. A non-AP wireless station (STA) comprising:
a controller configured to store a plurality of Enhanced Distributed Channel Access (EDCA) backoff parameters when enabling a prioritized EDCA (P-EDCA) channel access for low latency (LL) access category (AC); and
a wireless transceiver configured to perform the P-EDCA channel access by wirelessly transmitting a control frame to an AP using a plurality of P-EDCA parameters, wherein the P-EDCA parameters comprise at least one of an arbitration interframe space number (AIFSN) and a contention window value,
wherein the controller is further configured to resume an EDCA backoff procedure using the stored EDCA backoff parameters when a certain condition is met.

14. A method for wireless communications, the method comprising:
at a wireless device, storing a plurality of Enhanced Distributed Channel Access (EDCA) backoff parameters when enabling a prioritized EDCA (P-EDCA) channel access for low latency (LL) access category (AC);
at the wireless device, performing the P-EDCA channel access by wirelessly transmitting a control frame using a plurality of P-EDCA parameters; and
at the wireless device, resuming an EDCA backoff procedure using the stored EDCA backoff parameters when a certain condition is met.

15. The method of claim 14, wherein the wireless device comprises a non-access point (AP) station (STA) or an AP.

16. The method of claim 14, wherein the P-EDCA parameters comprise a P-EDCA parameter set for defer signal transmission.

17. The method of claim 16, wherein the P-EDCA parameter set for defer signal transmission comprises an arbitration inter-frame space number (AIFSN), a contention window (CW), and a defer signal retry counter.

18. The method of claim 14, wherein the P-EDCA parameters comprise a P-EDCA parameter set for request to send (RTS) transmission that follows defer signal transmission.

19. The method of claim 18, wherein the P-EDCA parameter set for RTS transmission comprises an arbitration inter-frame space number (AIFSN) and a contention window (CW).

20. The method of claim 14, further comprising retrying the P-ECDA channel access until the certain condition is met when the P-EDCA channel access is not successful.
